(19) United States
(12) Patent Application Publication
(10) Pub. No.: US 2026/0064998 A1
(43) Pub. Date: Mar. 5, 2026

(54) System

(71) Applicant: Softbank Group Corp., Tokyo (JP)

(72) Inventor: Jun Ichinose, Tokyo (JP)

(21) Appl. No.: 19/316,311

(22) Filed: Sep. 2, 2025

(30) Foreign Application Priority Data
Sep. 4, 2024 (JP) 2024-152660

(51) Int. Cl. G06F 40/58; G06F 1/16; G06V 20/20; G06V 20/62

(52) U.S. Cl. CPC G06F 40/58; G06V 20/20; G06V 20/63; G06F 1/163

(57) ABSTRACT

The system uses a processor to capture visual data via a wearable camera and audio data via a microphone. It transmits both types of data for analysis, extracts text from the visual data, identifies key keywords, and generates a summary using natural language processing. The audio is converted to text, translated, and the processed results are then sent back and displayed on the wearable device.

### CROSS-REFERENCE TO RELATED APPLICATION

This application claims priority under 35 USC 119 from Japanese Patent Application No. 2024-152660 filed Sep. 4, 2024, the disclosure of which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional wearable devices have limited ability to assist users in efficiently obtaining and understanding information from both visual and audio sources during real-world activities such as studying or communicating in foreign languages. There is a need for a system that can automatically extract and summarize important information from visual materials, convert audio into text, provide real-time translations, and seamlessly present this information to the user in an intuitive manner.

### SUMMARY

The present invention provides a system comprising a processor that captures visual information using a wearable device's camera and collects audio information using its microphone. The processor analyzes the transmitted visual information to extract text, applies natural language processing techniques to extract important keywords and generate summaries, analyzes and converts audio information into text, translates the converted text, and displays the analyzed and translated results on the wearable device. By integrating these functions, the system enables efficient acquisition, understanding, and real-time feedback of essential information for the user.

“Wearable device” means a portable electronic device designed to be worn on the body by the user, such as smart glasses or a headset, typically equipped with sensors, a camera, and a microphone.

“Camera” means an imaging device included in the wearable device, capable of capturing visual information such as images or video.

“Microphone” means an audio detection device included in the wearable device, capable of collecting audio information such as speech or environmental sounds.

“Visual information” means data captured by the camera, including but not limited to images, video, or other forms of light-based information.

“Audio information” means data captured by the microphone, including but not limited to spoken language, sounds, or other audible signals.

“Processor” means a central processing unit or microcontroller which executes program instructions to control and process data received from the wearable device.

“Extract text” means analyzing image or visual data to identify and convert embedded written characters into machine-readable text.

“Natural language processing techniques” means computational methods and algorithms used to analyze, process, and understand human language, including keyword extraction and text summarization.

“Summary” means a condensed version of the original extracted text, highlighting the main points or essential information.

“Keywords” means words or phrases identified as important or relevant within the extracted text, reflecting key concepts or topics.

“Convert audio to text” means transforming audio information, such as speech, into a written text format using speech recognition technology.

“Translate” means converting text from one language to another language using machine translation techniques.

“Real time” means processing and output occur with a minimal delay, enabling immediate or near-immediate feedback to the user.

“Transmit” means sending data electronically from one device or system component to another, such as from the wearable device to the processor or from the processor back to the wearable device.

“Display” means visually presenting information, such as summaries or translations, to the user through the output components of the wearable device, such as a screen or optical projector.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions; and

FIG. 10 illustrates an emotion map mapping plural emotions.

FIG. 11 is a sequence diagram showing the flow of data processing system processing in Example 1.

FIG. 12 is a sequence diagram showing the flow of data processing system processing in Application Example 1.

FIG. 13 is a sequence diagram showing the flow of data processing system processing in Example 2.

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

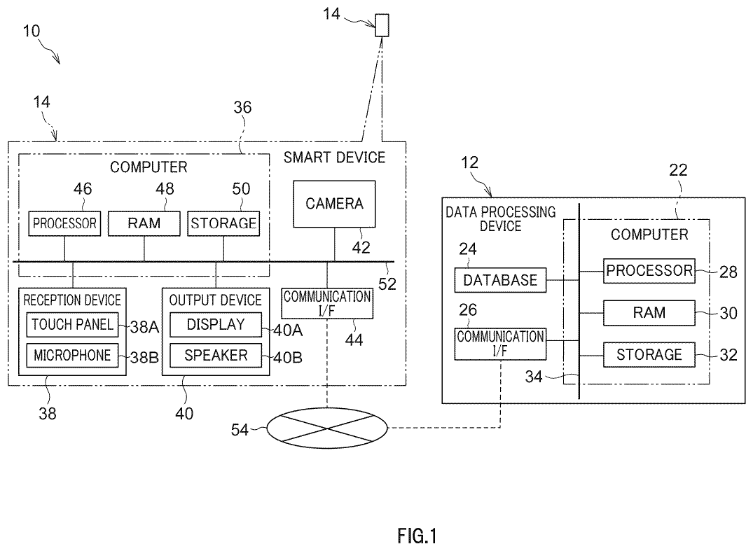

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

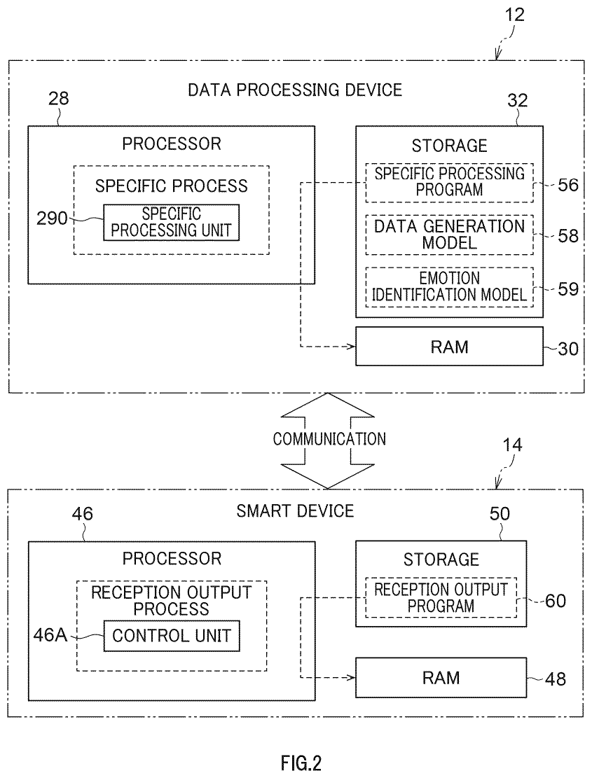

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems that utilize wearable devices have been unable to provide real-time and accurate feedback to users, as they lack efficient mechanisms for rapid collection, analysis, and dissemination of visual and audio information. In particular, existing technologies suffer from slow or imprecise extraction of important information from visual data, delayed and inaccurate real-time translation of audio data, and insufficient support for effective learning and multilingual communication. There is a demand for a system that can efficiently acquire images and audio using a wearable terminal, promptly analyze and summarize textual and audio information, and provide real-time, context-aware feedback and translations to users via an intuitive visual interface.

The specific processing by the specific processing unit 290 of the data processing device 12 in Example 1 is realized by the following means.

The present invention provides a server comprising a processor configured to acquire image and audio information from a wearable information processing terminal, analyze and extract character information using character recognition processing, extract important keywords and generate summarized content using language processing algorithms, convert obtained or received audio information to character information via speech recognition, apply translation processing to the generated or converted character information, and transmit the analyzed summary or translated results to be overlaid and displayed on a visually recognizable region of a wearable terminal, wherein a generative information generation model and associated control input sentences are utilized for information extraction and summarization. This enables efficient, real-time presentation of analyzed and translated information to users, thereby supporting effective learning and seamless multilingual communication.

The term “processor” refers to an electronic data processing apparatus or component configured to execute programmed instructions and perform operations as described in the system.

The term “information processing terminal” refers to a user-operated computational device, such as a wearable system, capable of acquiring, transmitting, and displaying information.

The term “image acquisition device” refers to a sensor, such as a camera or optical imager, integrated with the information processing terminal for capturing visual data of physical objects.

The term “audio acquisition device” refers to a sensor, such as a microphone, capable of capturing ambient audio signals in the environment.

The term “communication network” refers to a data transmission system that enables the exchange of information between the information processing terminal and an information processing device, such as via the Internet or other communications infrastructure.

The term “information processing device” refers to a computing apparatus, such as a server, that analyzes, processes, and manages information received from the information processing terminal.

The term “character recognition processing” refers to a computational method, including optical character recognition, which extracts textual information from visual data.

The term “language processing algorithm” refers to a computational technique or set of techniques for analyzing, summarizing, and extracting key information from text.

The term “speech recognition processing” refers to a computational process in which audio information is converted into machine-readable text data.

The term “translation processing” refers to a computational procedure for transforming textual data from one language into another language.

The term “summary information” refers to condensed textual data generated by extracting and synthesizing the main points from a larger set of textual information.

The term “control input sentence” refers to a prompt or instruction composed to guide a generative information generation model during information extraction or summarization.

The term “generative information generation model” refers to a computational model, such as a generative AI or language processing neural network, capable of generating new informational content, summaries, or extracted data from input signals.

The term “visually recognizable region” refers to an area within the display field of the information processing terminal in which images, text, or overlays can be perceptibly presented to the user.

The term “overlay-display” refers to a display mode that superimposes output information, such as summaries or translations, onto the user's real-world view via the terminal display.

The term “physical object” refers to any tangible entity in the environment that can be visually captured by the system.

The term “string information” refers to information expressed in a sequence of characters or text, obtained via character recognition or speech recognition.

One embodiment for carrying out the present invention is described below.

The system comprises an information processing terminal (such as a wearable device provided in the form of smart glasses), a processor incorporated in an information processing device (such as a server), and an image and audio acquisition subsystem. The terminal is equipped with an image acquisition device (such as a digital camera) and an audio acquisition device (such as a microphone), both integrated into the terminal's housing. The server and the terminal communicate via a communication network, such as the Internet, using secure protocols.

The user wears the terminal, which continuously or intermittently acquires image information representing physical objects (such as textbook pages or the environment in front of the user) with the camera, and audio information (such as conversational utterances or environmental sounds) with the microphone. These data are digitized and pre-processed on the terminal (for example, compressed into common digital formats), and subsequently transmitted via the communication network to the server.

The server, which comprises a processor, executes several software modules to analyze and process the received data. For example, the server may employ character recognition processing via an optical character recognition (OCR) software package such as open source Tesseract OCR, for extracting string information from the received image data. The processor then applies language processing algorithms such as Natural Language Toolkit (NLTK) or equivalent to the extracted string information, performing keyword extraction, summarization, or sentence generation.

For audio information, the processor applies speech recognition processing (using, for example, a speech-to-text API provided by a cloud service vendor) to generate string information from the received audio data. The server may then execute translation processing, for example using a generally available translation API, to convert the string information into a different language as specified by user settings.

The processor further generates a control input sentence (prompt sentence), which is used to guide a generative information generation model (such as a generative AI model or neural language model). For instance, when summarizing a textbook page, the processor creates a prompt sentence to instruct the model to extract and summarize the key points from the image-derived string data or audio-transcribed text.

After processing is completed, the server transmits the resulting summaries, keyword highlights, or translated strings to the information processing terminal. The terminal overlays this information within a visually recognizable region using a head-up display (HUD) or related augmented reality technology, allowing the user to immediately perceive the system-generated text superimposed on their field of view.

Specific hardware and software components include a wearable glass-type terminal with integrated camera and microphone, a high-performance information processing server, open source OCR software (such as Tesseract OCR), natural language processing tools (such as NLTK), speech recognition software (such as a cloud-based speech-to-text API), and translation software (such as an online translation API).

A concrete example is as follows:

The user puts on the smart glasses and opens a textbook. The terminal captures a photo of the page and records the user's voice if needed. The server employs OCR to extract text from the image, uses NLP to identify keywords and create a summary, optionally applies translation to convert the summary or keywords into another language, generates an appropriate prompt sentence to guide the generative AI model, and finally sends the results to the terminal for overlay display. In another scenario, the user starts a conversation in a foreign language; the terminal records the conversation, the server transcribes it to text and translates it, and immediate translation is visually superimposed for the user's reference.

Example of prompt sentence for summary generation:

“Extract the text from the following image and summarize the key points for efficient learning.”
(image: photo of a science or math textbook page)

Example of prompt sentence for real-time translation:
“Transcribe the following audio file into English text, then translate it into Japanese.” (audio: recorded conversation in English)

By combining these technologies, the present invention enables the user to acquire, understand, and communicate information efficiently and accurately, using a wearable terminal and advanced information processing functions implemented on an external server.

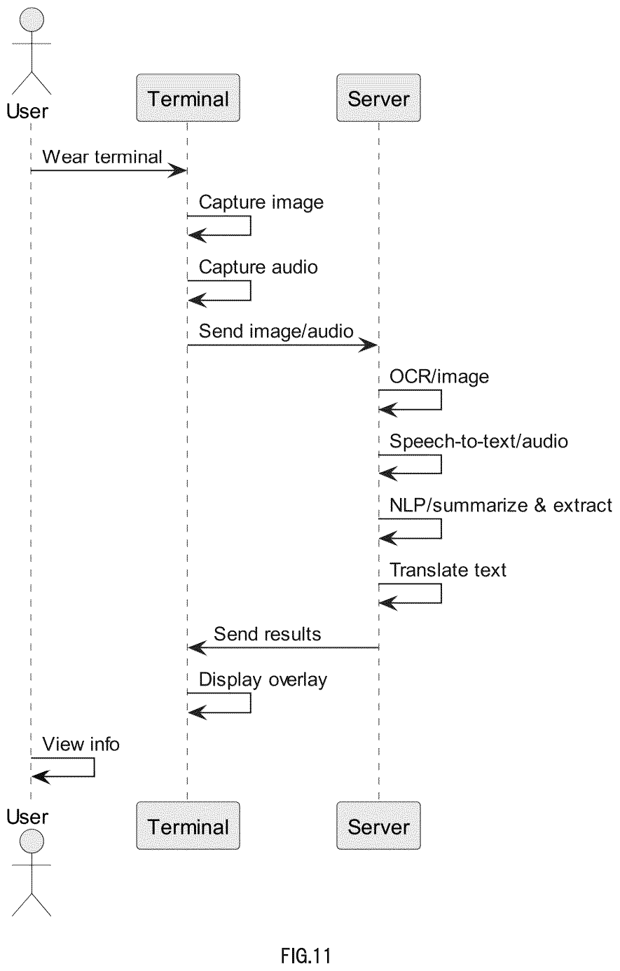

The following describes the processing flow using FIG. 11.

### Step 1:

User wears the information processing terminal in the form of smart glasses, ensuring the device is correctly positioned for image and audio capture.

Input: None.

Output: User equipped with the terminal, ready for data acquisition.

### Step 2:

Terminal activates its integrated camera and acquires image information of the user's field of view, for example, capturing a page from a textbook or a signboard.

Input: Visual scene in front of the user.

Operation: Terminal captures digital image data and stores it temporarily in memory.

Output: Image data representing the physical object.

### Step 3:

Terminal activates its integrated microphone and acquires audio information from the surrounding environment, such as spoken conversation or environmental sounds.

Input: Ambient sound near the user.

Operation: Terminal records audio and converts it into digital audio data.

Output: Audio data in a digital format.

### Step 4:

Terminal digitizes and, if necessary, compresses the image and audio data, then transmits the encoded data securely to the server via a communication network.

Input: Captured image data and audio data.

Operation: Terminal encodes and compresses data, establishes a secure channel, and uploads data to the server.

Output: Digital image and audio data transmitted to the server.

### Step 5:

Server receives the image data and performs character recognition processing using

OCR software to extract string information from the image.

Input: Received image data.

Operation: Server executes OCR, extracting text data from the visual content.

Output: Text data extracted from the image.

### Step 6:

Server applies a language processing algorithm, such as keyword extraction and summarization, to the extracted text to generate condensed string information and identify key vocabulary.

Input: Text data output from OCR.

Operation: Server analyzes the text, identifies main points, and produces a summary or keywords.

Output: Summary text and keywords.

### Step 7:

Server receives the audio data and applies speech recognition processing to convert spoken words into text.

Input: Received audio data.

Operation: Server uses speech-to-text software to transcribe the audio into machine-readable text.

Output: Transcribed text from audio data.

### Step 8:

Server applies translation processing to the summarized text or the transcribed text, as needed, converting it into the user's preferred language.

Input: Summary text, keywords, or transcribed text.

Operation: Server submits the text to a translation algorithm or service and obtains the corresponding translation.

Output: Translated text data.

### Step 9:

Server generates a prompt sentence as a control input for a generative AI model, when further extraction or summarization is to be performed. The prompt is used to guide the generative process for producing summaries or extracting information.

Input: Text data requiring summarization or extraction.

Operation: Server constructs a prompt sentence (for example: “Extract the key points for efficient learning from the following text.”) and applies it to the generative AI model.

Output: Refined summary or extracted information.

### Step 10:

Server packages the summarized, translated, or extracted information and transmits this output back to the terminal via the communication network.

Input: Processing results (summary, translation, extracted information).

Operation: Server creates a packet with output data and sends it securely to the terminal.

Output: Information package received by the terminal.

### Step 11:

Terminal decodes the received output and overlays the summary, keywords, or translation within a visually recognizable region using its head-up display or AR rendering engine.

Input: Received information package.

Operation: Terminal renders an augmented reality overlay in the user's field of view.

Output: Summarized or translated information displayed to the user.

### Step 12:

User visually perceives the overlaid information on the terminal display and uses it to support learning, communication, or other activities.

Input: Displayed summary, keywords, or translation.

Operation: User reviews the provided information and applies it to the ongoing task.

Output: Enhanced learning, communication, or situational awareness.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In industrial and educational environments, it is difficult to efficiently and accurately detect and communicate critical information, abnormal situations, or user status in real time using conventional systems. Existing solutions are limited in their ability to integrate and process visual, audio, and emotional data simultaneously, leading to delays in abnormality detection, ineffective feedback, and a lack of personalized support for users, such as workers or learners. Hence, there is a need for a comprehensive system that can acquire, process, and return multimodal data with advanced analysis functions to provide immediate, context-aware support and feedback.

The specific processing by the specific processing unit 290 of the data processing device 12 in Application Example 1 is realized by the following means.

The present invention provides a server comprising a processor configured to acquire environmental information via an optical information acquisition component of a wearable terminal, acquire audio information, encrypt and transmit these multimodal data to an external information processing apparatus, perform character recognition and natural language processing on visual data, perform speech recognition and translation on audio data, execute emotion estimation, and return analyzed and context-adapted results to the wearable terminal. This enables real-time, intelligent extraction and delivery of critical information and feedback, including abnormality alerts and emotion-adaptive content, thus improving operational safety, efficiency, and personalized support for users.

The term “processor” refers to a data processing unit or circuit that executes instructions and controls the operation of the system.

The term “optical information acquisition component” refers to a hardware device, such as a camera or image sensor, that captures visual or image data from the environment.

The term “body-mounted information terminal” refers to an electronic device wearable by a user, such as smart glasses, smart watches, or other wearable computing devices.

The term “audio information acquisition component” refers to a hardware device, such as a microphone, that captures audio data, including speech or environmental sounds. The term “external information processing apparatus” refers to a remote or network-connected computing device, such as a server, that receives, processes, and analyzes data sent from a terminal.

The term “environmental information” refers to data related to the user's surroundings, including visual, image, or video data obtained by an optical information acquisition component.

The term “audio information” refers to data representing sounds or speech, captured by an audio information acquisition component.

The term “character recognition processing” refers to a computational method for detecting and extracting textual information from image data, typically using optical character recognition (OCR) technology.

The term “natural language processing technology” refers to computational techniques for analyzing, extracting, or summarizing meaningful information from text data in human language.

The term “audio signal recognition technology” refers to a computational method for analyzing audio data and converting it to symbol representations, such as transcripts of spoken words, typically using speech recognition algorithms.

The term “symbol information” refers to text or other coded representations derived from audio signals or other data sources.

The term “information representation” refers to the format or expression in which information is presented, such as text, audio, or visual display.

The term “emotion estimation technology” refers to computational methods or models for analyzing data, such as audio signals or image frames, to determine or predict a user's or subject's emotional state.

The term “demand terminal” refers to a user-operated device, such as a wearable terminal or client terminal, that receives, displays, and interacts with the processed information from the server.

The term “display control” refers to functions or processes that manage how analyzed or processed information is presented on the terminal's user interface, including visual or auditory notifications.

### Embodiment for Implementing the Invention

The present invention may be implemented as a system comprising a processor, a body-mounted information terminal, and an external information processing apparatus. The processor of the system is configured to acquire visual and audio data from the environment by means of an optical information acquisition component, such as a camera, and an audio information acquisition component, such as a microphone, both embedded in the body-mounted information terminal. Examples of such body-mounted information terminals include smart glasses, wearable computers, or other head-mounted devices.

The terminal encodes the acquired environmental (visual) and audio data into digital formats (such as JPEG, PNG, PCM, or FLAC) using embedded software and transmits the encrypted data to the external information processing apparatus, which functions as a centralized server. This transmission may utilize secure protocols such as HTTPS, and hardware interfaces such as Wi-Fi, Ethernet, or cellular modules.

The server, implemented as a networked computer system, is equipped with software modules for data processing and analysis. For character recognition processing on received image data, the server may utilize open-source image processing libraries, such as OpenCV, and optical character recognition software, such as Tesseract. The server applies these tools to extract textual information from the received images.

The extracted text is further processed by natural language processing (NLP) software libraries, such as spaCy or NLTK, running on the server. These tools are used to extract important information and to generate compressed or summarized versions of longer passages for efficient display on wearable or mobile user interfaces.

For audio information, the server uses audio signal recognition software, such as the SpeechRecognition library or an equivalent speech-to-text engine, to convert audio data into symbolic representations, typically in the form of text. If translation is required, the server may interface with an external translation API, such as Google Translate via googletrans, to convert the transcribed text into the user's preferred language or other target languages.

An additional feature of the invention is emotion estimation technology. The server processes either audio data (to extract voice emotional features) or facial image data, using machine learning frameworks such as TensorFlow or Keras for emotion classification, or software like OpenFace for facial expression analysis. The detected emotion is linked to the analyzed information and may be used to adjust the content or urgency of feedback provided to the user.

The analyzed and context-adapted results, including extracted key information, summaries, translations, and emotion estimation, are re-packaged and transmitted by the server to the user's terminal. The terminal decodes the received data and displays or plays it for the user in an accessible, context-aware format, with display control functions adjusting the layout and presentation according to content type and user state.

For example, when implemented in an industrial environment, the terminal (such as a wearable device on a factory worker) collects images and audio near a production line. The server detects any abnormal status (such as warning messages on machine panels) and synthesizes a concise alert, possibly with a recommendation based on the user's emotional state. The processed alert and advice are displayed visually or audibly to the worker in real-time, enabling immediate action.

In an educational scenario, the terminal may capture textbook pages and spoken language during study sessions. The server summarizes key textbook content and provides translations or explanations, with advice or encouragement tailored to the user's detected emotion, thus supporting personalized learning.

Hardware for implementing the invention includes general-purpose computers as servers, body-mounted devices with embedded cameras and microphones, and network communication equipment. Software may be developed in languages such as Python, using libraries such as OpenCV, Tesseract, spaCy, NLTK, SpeechRecognition, TensorFlow, Keras, and OpenFace.

Examples of prompt sentences for interaction with a generative AI model include:
Describe in detail the step-by-step process by which a wearable smart glasses device captures user data, sends it to a server, receives analyzed feedback (including emotion and summary), and presents actionable advice to the user.
Explain how a server processes received images and audio from a factory terminal, extracts keywords using OCR and NLP, detects user emotion, and supports real-time decision-making on the factory floor.
Show concrete examples of how visual and audio analysis can improve factory work efficiency.
Explain the benefits and use cases of incorporating emotion recognition into real-time factory or learning environments.

This embodiment allows for real-time, context-aware processing, analysis, and feedback of multimodal data to support efficient operation, safety, and personalized experience in both industrial and educational settings.

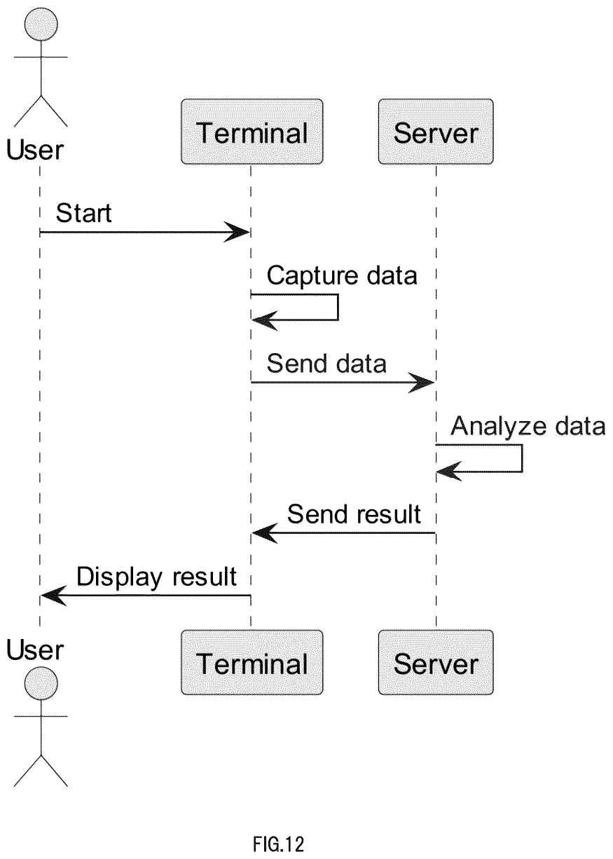

The following describes the processing flow using FIG. 12.

### Step 1:

The terminal initializes hardware components including the camera and microphone, and enters standby mode for data acquisition. The input is a control signal for activation (e.g., user button press or scheduled timer), and the output is the activation of hardware components ready to collect data.

### Step 2:

The terminal captures image data from the environment using the camera and records audio data using the microphone, simultaneously storing the data temporarily in digital formats such as JPEG/PNG for images and PCM/FLAC for audio. The input is the real-world scene or sound, and the output is digital files containing captured image and audio data.

### Step 3:

The terminal encodes the collected image and audio data, attaches metadata such as timestamp and device ID, encrypts the data packets, and establishes a secure wireless or wired transmission to the server using standard communication protocols like HTTPS. The input is the digital image and audio files; the output is encrypted, metadata-tagged data packets sent to the server.

### Step 4:

The server receives incoming packets through a web service interface, decodes the data, and verifies integrity/authenticity based on the metadata and encryption keys. The input is the encrypted data packet from the terminal; the output is securely decoded image and audio data, ready for processing, stored in the server's filesystem or database.

### Step 5:

The server preprocesses the image data using an image processing library (such as OpenCV) to adjust image quality (cropping, denoising, correcting orientation), then applies an OCR engine (like Tesseract) to extract any textual content from the image. The input is the raw image data; the output is a text string containing recognized characters or words from the image.

### Step 6:

The server processes the extracted text using a natural language processing library (such as spaCy or NLTK), identifying important keywords and generating a summary or categorization of the text. The input is the OCR-extracted text; the output is a list of keywords and a condensed summary for efficient review by the user.

### Step 7:

The server decodes the audio data and processes it with a speech recognition engine (such as SpeechRecognition or cloud API), transcribing the audio into text. If required, the transcribed text is sent to a translation service (such as Google Translate via googletrans) to provide a version in the user's preferred language. The input is the audio data; the output is the transcribed and, if needed, translated textual content.

### Step 8:

The server analyzes emotional indicators in audio features (tone, rhythm) or facial expressions extracted from image frames with a facial recognition/emotion analysis library (such as OpenFace or a neural network model running on TensorFlow/Keras), classifying the user's emotional state (e.g., “neutral”, “anxious”, “confident”). The input is either audio or image data; the output is an emotional state label.

### Step 9:

The server packages the analyzed results-keywords, summaries, translated text, and emotion label-into a structured data packet (e.g., JSON), and transmits this feedback to the terminal over the network. The input is the aggregated analysis results; the output is a formatted feedback packet sent to the terminal.

### Step 10:

The terminal receives and decodes the feedback packet, determines the optimal mode of notification (visual display, audio alert, or combination), and renders the information using readable formatting and color coding appropriate to the content (e.g., red for alerts, blue for information, or icons for emotion). If necessary, the terminal activates haptic or acoustic notifications (such as vibration or sound cues) for urgent messages. The input is the feedback packet from the server; the output is visually, audibly, or tactilely presented information for the user.

### Step 11:

The user reviews the displayed or played feedback on the terminal, interprets the results (such as identifying an alert or suggestion), and takes responsive action (e.g., addressing a machine issue, responding to a conversational recommendation, or continuing a learning activity). The input is the presented feedback; the output is the user's informed action or response, which may be logged by the terminal for future analysis.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional wearable device systems that provide information support or communication assistance are limited in their ability to integrate and analyze both visual and audio information in real time. Such systems do not consider the emotional state of the user, resulting in simple information delivery without optimization for the user's learning efficiency or communication experience. There is a need for a system that can acquire, analyze, and integrate visual and audio information, recognize the user's emotional state, and provide personalized, real-time feedback to enhance the user's experience and effectiveness.

The specific processing by the specific processing unit 290 of the data processing device 12 in Example 2 is realized by the following means.

The present invention provides a server comprising a processor configured to acquire external information and audio information from an information processing device, analyze and extract symbolic information, summarize and extract key points using natural language techniques, convert audio information to symbolic information and perform language conversion, and further extract the user's emotional state using emotion determination technology, wherein the analysis result, language conversion result, and emotional state are integrated and visually displayed to the user in real time via the information processing device. This enables the system to deliver integrated, real-time, and personalized feedback based on both sensory input and emotional recognition, thereby improving the user's learning and communication experience.

The term “information processing device” refers to an electronic apparatus capable of executing various processing tasks, including data collection, transmission, and display, such as a wearable device or portable terminal.

The term “imaging unit” refers to a component or module, such as a camera, that is configured to capture external visual information and convert it into digital image data.

The term “acoustic sensor unit” refers to a component or module, such as a microphone, that is capable of capturing audio signals from the environment and converting them into digital audio data.

The term “external information” refers to visual data, including images or video, that is captured from the environment surrounding the information processing device. The term “audio information” refers to sound data, including speech or other environmental sounds, acquired by the acoustic sensor unit.

The term “information analysis device” refers to any electronic system, such as a server or remote processor, capable of receiving, processing, and analyzing information transmitted from the information processing device.

The term “symbolic information” refers to data that has been extracted and represented in the form of symbols, such as characters or recognized text, derived from visual or audio sources.

The term “natural language related technology” refers to computational techniques and algorithms capable of processing, extracting, and summarizing information from text-based symbolic information.

The term “summarization” refers to the process of extracting essential content from data and generating a condensed version maintaining the core information.

The term “key point extraction” refers to identifying and selecting important words, phrases, or segments from a set of data that reflect the central topics or relevant details.

The term “language conversion processing” refers to the process of translating symbolic information from one language to another using computational methods. The term “emotion determination technology” refers to algorithms or computational systems designed to analyze data such as visual images or audio signals to identify or infer the emotional state of a user.

The term “attribute states” refers to characteristics or interpretations, such as emotional conditions, that are extracted from visual or audio information through analysis.

The term “perceptible region” refers to the area within the user's field of view where visual information can be presented and perceived, such as a display on a wearable device.

The term “integrated information” refers to information that has been collectively processed and combined from multiple sources or analyses, and that can be presented as a unified output to the user.

An embodiment for implementing the invention will be described as follows.

The system comprises an information processing device (such as a wearable device) and an information analysis device (such as a server), each of which cooperate to provide integrated, real-time feedback to a user based on visual and audio information as well as the user's emotional state.

The terminal, which is an information processing device, may be a wearable device equipped with a camera (imaging unit), a microphone (acoustic sensor unit), a wireless communication module, and a display component. Example hardware configurations for the terminal include smart glasses or other head-mounted displays with camera and microphone functionality.

The terminal uses the built-in camera to acquire external information, such as images or video of the user's surroundings. The terminal further uses the microphone to acquire audio information, such as the user's speech or environmental sounds. The terminal encodes the image data (for example, in JPEG format) and audio data (for example, in WAV format) and transmits these datasets to the information analysis device (server) via a communication network such as Wi-Fi or cellular data.

The server is implemented using a high-performance computing system capable of receiving, processing, and analyzing incoming data from multiple terminals. On the server side, software modules are utilized to process the data. Example software includes:
An optical character recognition (OCR) module, such as a general-purpose image-to-text conversion library or cloud service.
A natural language processing (NLP) module, which may use programs such as a tokenization, keyword extraction, and text summarization package.
An automated speech recognition (ASR) module, which receives audio data and converts it to text using a standard speech-to-text library or cloud API.
A translation engine that translates textual data from one language to another.
An emotion recognition engine, such as a facial analysis or voice tone analysis program, to determine the emotional state of a user.

The server analyzes the received visual information (e.g., image data) using the OCR module to extract symbolic information in the form of text. The extracted text is then further processed by the NLP module to identify key points and generate a summary. Audio information is converted to text by the ASR module and, if necessary, translated to another language by the translation engine. The server uses emotion determination technology to analyze facial expressions or audio signals for emotional state detection. The server integrates these analysis results into a single feedback dataset and transmits this information back to the terminal.

The terminal receives this feedback dataset and visually presents the text summary, translation, and emotional status to the user through the display component. The presentation may include adjusting the position and formatting of information to ensure visibility within the wearer's field of view.

The user can view these results in real time via the display of the wearable device. Based on the displayed feedback, the user can choose to continue studying, proceed with conversation, or adjust their own actions according to their emotional state.

For example, if a user is reading a mathematics textbook, the terminal captures an image of the textbook using the camera. The server extracts and summarizes relevant textual information using OCR and NLP, and detects that the user appears focused or satisfied based on facial analysis. The feedback including the summary and emotional state is displayed to the user, enabling the user to make informed decisions regarding their study.

Another example involves foreign language conversation. When the user speaks in a foreign language while wearing the terminal, the system collects audio data, performs speech recognition and translation, and provides both the translation and emotion feedback in real time, thereby supporting the user in cross-language communication.

Example prompt sentences for the generative AI model include:
“Summarize the key points of the textbook page the user is viewing and describe the user's emotional state in real time.”
“When the user speaks a foreign language, provide a real-time translation and analyze user emotions, then offer both as feedback.”

The present embodiment therefore allows for immediate, context-aware, and personalized assistance to the user by leveraging various data processing and artificial intelligence techniques on standard information processing and analysis devices.

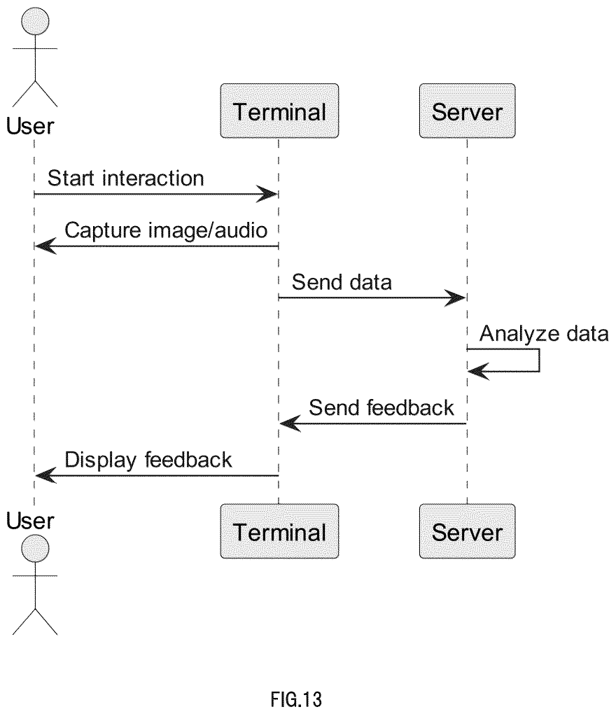

The following describes the processing flow using FIG. 13.

### Step 1:

Terminal activates the imaging unit and acoustic sensor unit to acquire external information and audio information from the user's environment. The input is the real-world scene observed and the surrounding sounds. The terminal processes this by capturing an image (e.g., a textbook page) in JPEG format and recording audio (e.g., conversation) in WAV format. The output is the JPEG image file and WAV audio file.

### Step 2:

Terminal encodes and transmits the collected JPEG image file and WAV audio file to the server via a communication network such as Wi-Fi. The input is the encoded image and audio data. The terminal performs data packaging and uses a wireless communication module to upload the data. The output is successful delivery of the image and audio data to the server.

### Step 3:

Server receives the JPEG image and WAV audio data and decodes both into formats ready for analysis. The input is the package of data received from the terminal. The server extracts and decodes the captured files, verifying data integrity. The output is decoded image data and decoded audio data.

### Step 4:

Server applies an optical character recognition module to the decoded image data to detect and extract any symbolic information in the form of text. The input is the decoded image. The server runs OCR algorithms to analyze the image and identify any readable characters. The output is extracted text data from the image.

### Step 5:

Server applies a natural language processing module to the extracted text data in order to perform key point extraction and summarization. The input is the text obtained from OCR. The server processes the text, identifies important keywords, and generates a summary using NLP techniques. The output is a summary and a list of key points from the extracted text.

### Step 6:

Server applies an automated speech recognition module to the decoded audio data in order to transcribe speech into symbolic information in the form of text. The input is the decoded audio data. The server processes the audio through a speech-to-text algorithm to generate the recognized speech as text. The output is transcribed text from the audio information.

### Step 7:

Server applies a translation module to translate the transcribed text into a target language, when necessary. The input is the transcribed text. The server sends this text to a translation program and receives the translated result. The output is the translated text.

### Step 8:

Server applies emotion determination technology to both the image and audio data in order to extract attribute states such as the user's emotional condition. The input is the captured image and audio data. The server processes these through an emotion recognition algorithm, evaluating facial expression and voice tone, to categorize emotional attributes. The output is an emotion classification (e.g., “happy”, “focused”, “confident”).

### Step 9:

Server integrates the summary, keywords, translated text, and emotion classification into a comprehensive feedback dataset. The input is the set of analysis results from prior steps. The server formats the integrated information into a display-ready dataset (such as a JSON object). The output is a feedback package ready for user presentation.

### Step 10:

Server transmits the feedback dataset to the terminal via the communication network. The input is the feedback package. The server sends the integrated feedback to the terminal using secure data transmission. The output is successful delivery of the feedback data to the terminal.

### Step 11:

Terminal receives and decodes the feedback dataset. The input is the integrated feedback data. The terminal unpacks and formats the content for visual presentation, adjusting layout and display parameters for the user's wearable display. The output is a set of display commands ready to present the feedback information.

### Step 12:

Terminal displays the summary, translation, keyword list, and emotional state information in the user's perceptible region via the wearable display. The input is the formatted feedback content. The terminal renders the feedback so the user can read the information directly in their field of view. The output is the visual presentation of real-time, personalized feedback to the user.

### Step 13:

User views the displayed feedback and decides on the next action, such as continuing to read, changing study focus, or adapting their communication. The input is the feedback information presented in the display. The user interprets the displayed information and takes an appropriate action. The output is the user's continued interaction, learning behavior, or communication, informed by the feedback.

### Step 14:

Terminal may repeat the data acquisition process as the user interacts further, enabling continuous real-time feedback. The input is the user's new activity and environmental changes. The terminal restarts the process at Step 1, allowing the cycle to continue as needed. The output is continuous, adaptive support to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventionally, it has been challenging for information acquisition and feedback systems utilizing wearable devices to provide real-time, personalized feedback that dynamically reflects the user's emotional state as well as contextual information extracted from both visual and audio data. Existing systems often offer uniform feedback without adapting to individual user needs or emotional status, making individualized support and guidance in environments such as physical stores or educational institutions difficult. Additionally, conventional systems lack an integrated approach for multimodal data analysis, emotional recognition, and natural language generation based on both extracted context and user states.

The specific processing by the specific processing unit 290 of the data processing device 12 in Application Example 2 is realized by the following means.

The present invention provides a server comprising a processor configured to acquire visual and audio data from a wearable device, extract and summarize contextual information, analyze and translate speech input, estimate the emotional state of the user, and generate personalized feedback messages by using a generative processing engine based on instruction information as input. This enables dynamic, real-time adaptation of feedback to the user's context and emotional state, enhancing the personalization and effectiveness of support provided through wearable technology.

The term “processor” refers to an information processing unit capable of executing instructions, managing data input and output, and performing computational tasks required by the system.

The term “image acquisition unit” refers to a device or component, such as a camera or image sensor, that is capable of capturing visual information in the form of digital images or video.

The term “acoustic sensor” refers to a hardware component, such as a microphone or sound sensor, that is capable of capturing audio signals from the environment.

The term “audio data” refers to electronic information representing sounds, including speech, captured through an acoustic sensor.

The term “information processing device” refers to an electronic apparatus, such as a server or computer, that receives, processes, and analyzes information or data transmitted from other devices.

The term “character data” refers to text or alphanumeric information extracted from visual or audio sources by processing digital data.

The term “information extraction processing” refers to the process of analyzing input data to identify, extract, and convert relevant content, such as text from an image, into usable character data.

The term “key components” refers to important elements, words, or phrases within extracted character data, determined through a process of analysis such as natural language processing.

The term “summary information” refers to a condensed or paraphrased version of the original extracted or analyzed data, highlighting essential points for ease of understanding.

The term “audio analysis processing” refers to the conversion of audio signals into character data and the subsequent analysis of the content, such as by recognizing speech and extracting meaning.

The term “translation processing” refers to the conversion of character data from one language to another using computational linguistic techniques.

The term “display information” refers to data or content generated for and transmitted to a device with a display function, intended for visual presentation to the user.

The term “information display device” refers to any device capable of visually presenting processed information, such as a wearable display or smart glasses.

The term “analysis target data” refers to data selected for the purpose of detailed examination or processing within the system workflow.

The term “user state recognition data” refers to data reflecting the status, behavior, or emotion of the user, which may be determined through sensor inputs or analysis.

The term “emotional state” refers to an assessment or estimation of the user's feelings or mood, such as being relaxed, tense, or interested, as determined by the system.

The term “output information” refers to the final, generated data or message that is based on analysis and is to be provided or displayed to the user.

The term “information presentation device” refers to an apparatus configured to provide output information to the user in an accessible manner, such as by auditory or visual means.

The term “generative processing engine” refers to a computational model or software module, including but not limited to artificial intelligence models, capable of creating or generating new content based on given instruction information.

The term “instruction information” refers to input data, including prompt sentences or contextual cues, that guides the operation of the generative processing engine in generating output information.

The term “target region” refers to a specific portion within the acquired information identified as relevant for further analysis.

The term “predetermined data” refers to specific information or data types that are designated for analysis within a specified context.

The term “speech recognition processing” refers to the process of converting spoken audio data to character data using computational techniques.

The term “recognition result” refers to the outcome of converting audio data into character data via speech recognition processing.

The term “real-time” refers to operations that are performed and results that are generated with minimal delay, suitable for immediate feedback or action.

### Embodiment for Implementing the Invention

A system according to the present invention may be implemented using general-purpose computing components and wearable technologies configured to enable acquisition, analysis, and presentation of multimodal data. The system comprises at least a terminal, such as a wearable device, and a server performing data processing and feedback generation.

The terminal may be a wearable information device, for example, smart glasses or a head-mounted display equipped with an image acquisition unit (such as a camera) and an acoustic sensor (such as a microphone). The terminal is configured to acquire image data of objects in the environment, such as product labels or signs, and to collect audio data, including environmental sound or user conversation. The terminal digitizes and transmits these data via a wireless communication interface-such as Wi-Fi or LTE network modules—to a remote server for further processing.

The server is configured to store, process, and analyze received visual and audio data. The server may use software modules implementing character recognition technology (such as an OCR engine), speech-to-text processing (for example, speech recognition APIs), translation processing (using translation APIs), and natural language processing algorithms (such as AI-powered language models). In one embodiment, the server further deploys an emotional analysis unit based on an emotion recognition engine that operates on features derived from received data, including acoustic and visual cues.

Specifically, the server applies the OCR engine (such as a generic text recognition API) to extract character data from images sent by the terminal. The server then analyzes the extracted text using a natural language processing toolkit (such as a generative AI model or general-purpose language analysis API) to extract key components and generate summary information.

For audio data, the server performs speech recognition using a speech-to-text engine, which may be implemented with a generic speech recognition API. The transcript is then analyzed, and, if necessary, translated into another language using a translation API. The server may further apply a generative AI model to summarize, paraphrase, or organize transcribed textual information, and to compose personalized feedback messages based on integrated context and user state.

A distinctive feature of the present system is the estimation of the user's emotional state through an emotion recognition pipeline that analyzes the received voice signals and, where available, visual factors. The server stores the estimated emotional state results along with context and synthesis data.

Based on summary information, translated content, and emotional state, the server formulates a prompt sentence and uses a generative processing engine (for example, a generative AI model) to generate output information, such as guidance or recommendations for the user. The result is structured as display information and is transmitted back to the terminal. The terminal decodes this information and overlays it onto the user's field of view using its built-in display capabilities, such as augmented reality rendering engines built for wearable device platforms.

Users are thus able to interactively receive personalized, context-sensitive feedback and guidance, directly within their visual environment. For example, when a user is shopping and focuses on a particular product, the terminal captures the product label image and audio of their question to the staff. The server analyzes these data, summarizes the product information, recognizes that the user is calm, and generates a supportive answer for display such as:

“Yes, this product is suitable for sensitive skin. Would you like more details?”

Prompt sentence examples used for the generative AI model may include:

“Product image: [Extracted text data]. Please summarize the key features for a consumer, ignoring background information.”

“Audio transcript: ‘Can you recommend a shampoo for sensitive skin?’ Detected emotion: ‘relaxed’. Compose a brief, helpful response suitable for display on a wearable device.”

“Customer's emotional state: ‘tense’. Suggest a reassuring message based on the conversation transcript: ‘I'm not sure which product to choose.’”

This embodiment can be realized using standard computer hardware, wearable smart devices, and by utilizing widely available software technologies for image analysis, speech recognition, machine translation, and generative language models. All components can be integrated through secure network protocols and standard application programming interfaces (APIs).

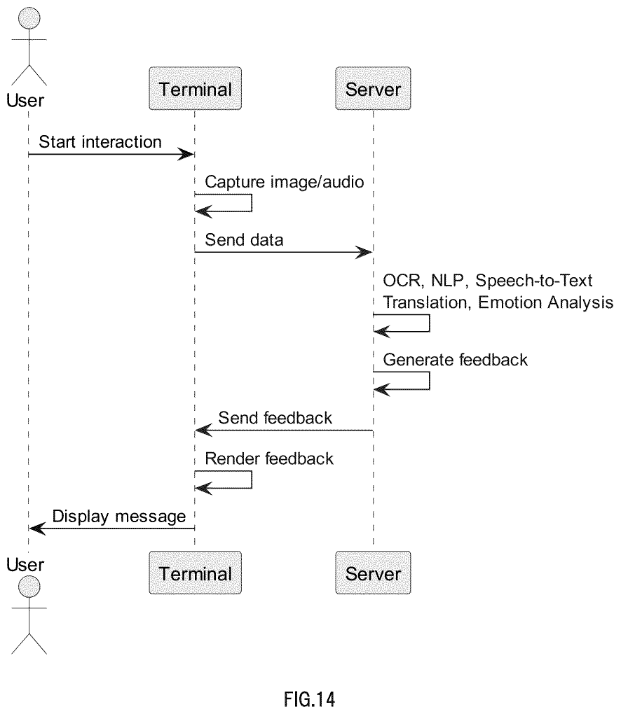

The following describes the processing flow using FIG. 14.

### Step 1:

The terminal activates its image acquisition unit and acoustic sensor when the user initiates operation, such as entering a store. The terminal captures visual data (such as images of products or signage) and records audio data (such as user speech or environmental sounds). Input: Real-world visual scenes and ambient audio as perceived by the user.

Operation: The terminal digitizes the data using internal hardware drivers and encodes it for efficient transmission.

Output: Digitized image data and audio data files.

### Step 2:

The terminal establishes a wireless communication session with the server and transmits the digitized image and audio data files.

Input: Digitized image data and audio data files generated in Step 1.

Operation: The terminal groups the files into data packets and sends them securely via network protocols.

Output: Data packets containing image and audio data received by the server.

### Step 3:

The server receives the transmitted data packets and stores the image and audio data for processing. The server initiates image analysis by applying an OCR engine to extract any textual elements present in the received images.

Input: Image data from data packets transmitted by the terminal.

Operation: The server runs image recognition algorithms to detect and extract character strings from the image, converting them to text format.

Output: Extracted text data corresponding to, for example, product information or signage.

### Step 4:

The server processes the extracted text using natural language processing technology to identify key components, such as product names or features, and to generate a summary of the content.

Input: Extracted text data from Step 3.

Operation: The server applies language parsing and summarization models to reduce the text to its essential content.

Output: Key components and summarized product or contextual information.

### Step 5:

The server performs audio analysis by applying a speech recognition engine to convert the received audio data to text, followed by optional translation using a translation API.

Input: Audio data from data packets transmitted by the terminal.

Operation: The server runs speech-to-text algorithms to transcribe user speech, and optionally calls a translation service to convert the transcription to another language.

Output: Transcribed and, if necessary, translated text data.

### Step 6:

The server applies an emotion recognition engine to both the transcribed audio and, if available, visual cues from the captured images to estimate the user's emotional state (for example, “relaxed” or “tense”).

Input: Audio data and/or image data as context, along with transcribed/translated text.

Operation: The server analyzes tone, pitch, visual expressions, or other indicators using trained models to estimate the user's emotion.

Output: Emotional state estimation data.

### Step 7:

The server combines the summarized information, translated content, and emotional state into a context-rich prompt sentence. The server then inputs this prompt into a generative AI model, which produces a personalized feedback message appropriate for the user's situation.

Input: Summarized information, translated text, and emotional state estimation from previous steps.

Operation: The server constructs a prompt such as “Product summary: . . . ; User question: . . . ; Detected emotion: . . . ; Generate a friendly, helpful message.” The generative AI model outputs a tailored response message.

Output: Generated feedback message.

### Step 8:

The server packages the generated feedback message and transmits it back to the terminal using secure communication channels.

Input: Personalized feedback message generated in Step 7.

Operation: The server encodes the message and sends it to the terminal in a display-ready format.

Output: Feedback message received by the terminal.

### Step 9:

The terminal decodes the feedback message and renders it as an overlay in the user's display (such as augmented reality view in smart glasses).

Input: Feedback message received from the server.

Operation: The terminal uses its rendering engine to present the message within the user's field of vision with appropriate formatting (such as font size and position).

Output: The user visualizes the feedback message as part of their augmented reality experience.

### Step 10:

The user reviews the feedback message displayed on the terminal and takes action accordingly, such as making a purchase decision or asking further questions.

Input: Feedback message rendered by the terminal.

Operation: The user interprets the information and determines the next action in their interaction context.

Output: User action based on the augmented feedback information.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

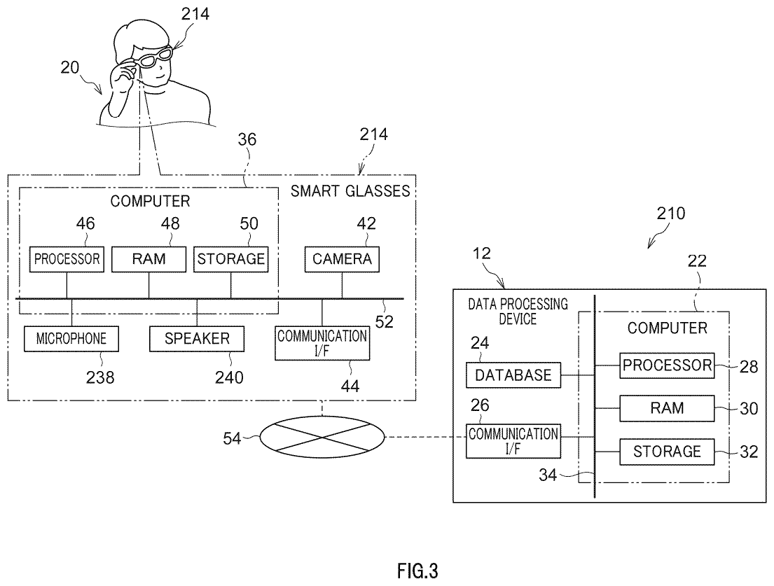

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

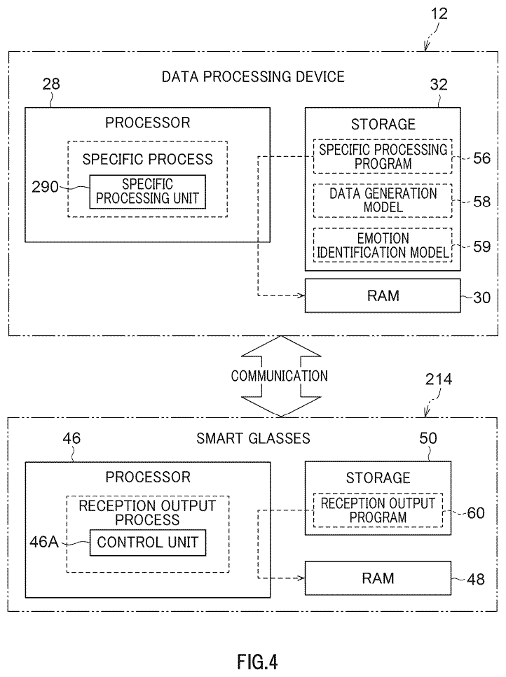

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

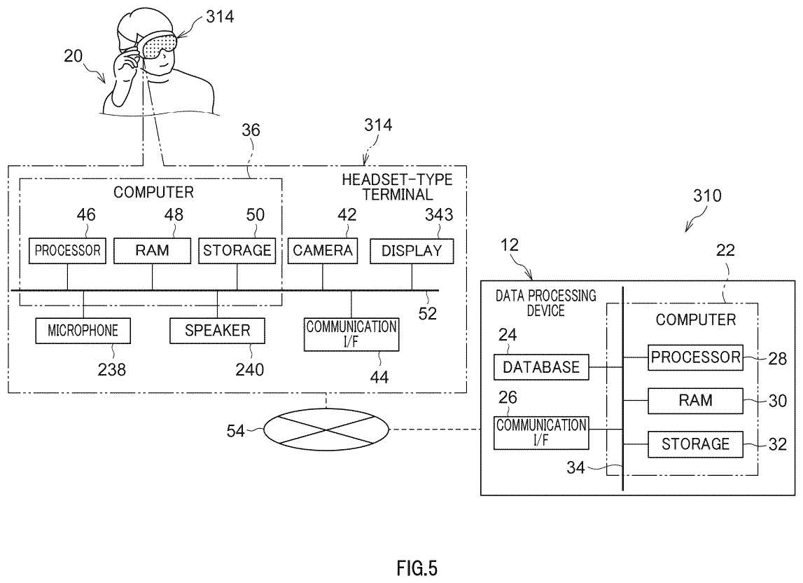

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

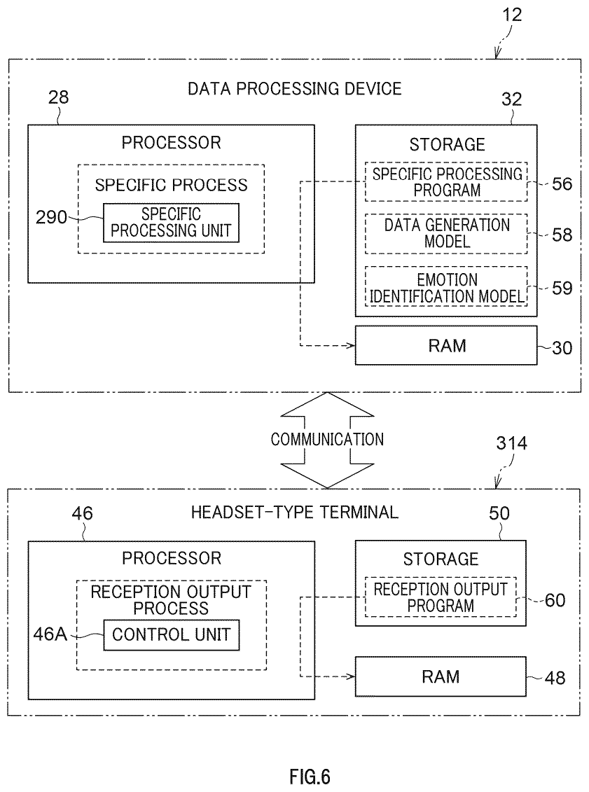

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

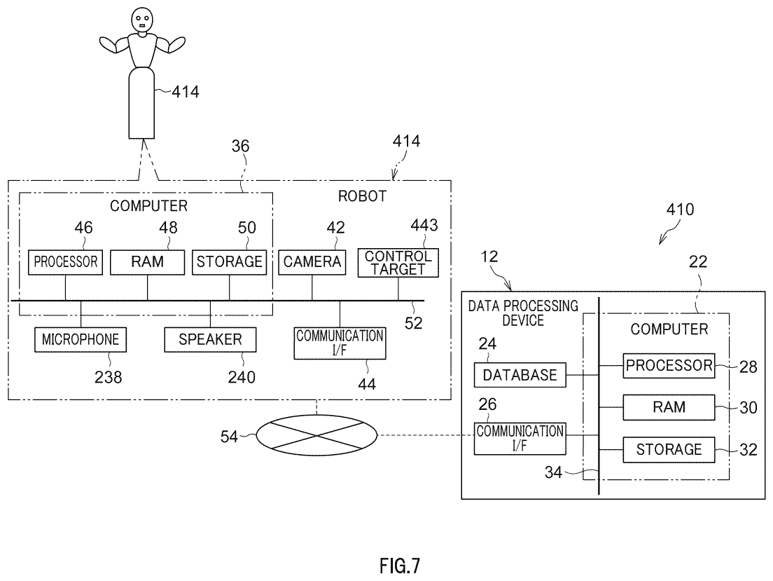

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

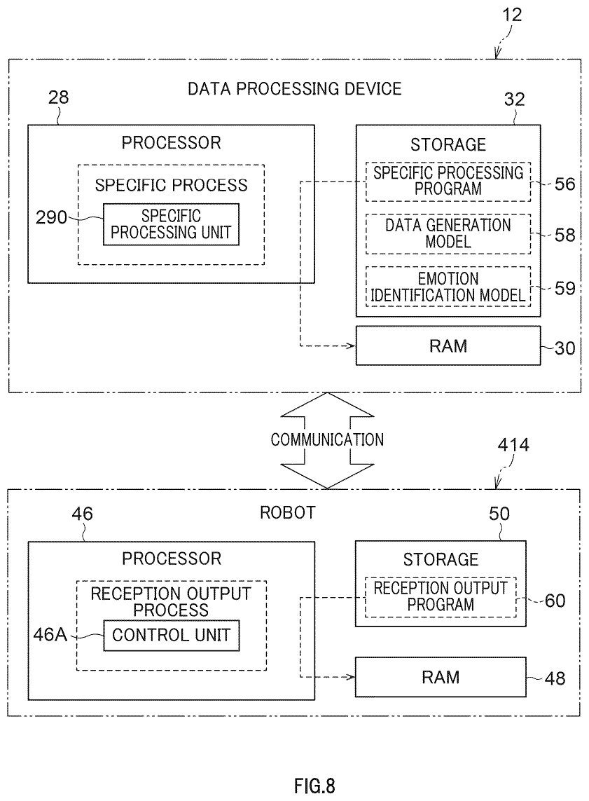

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

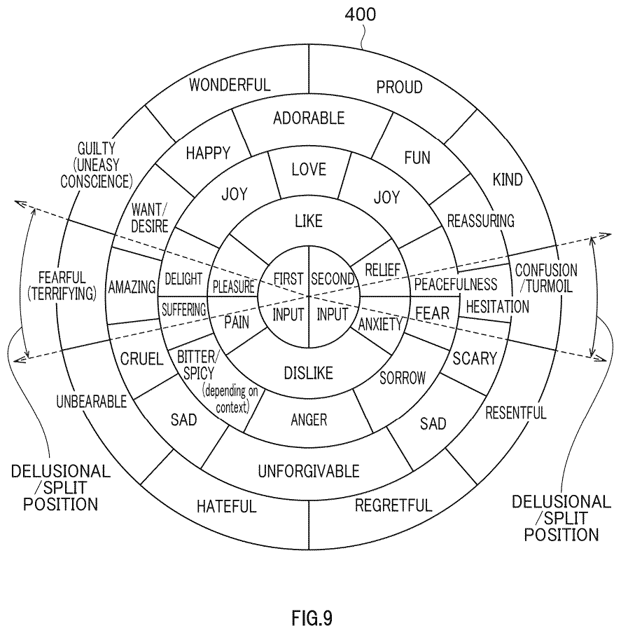

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

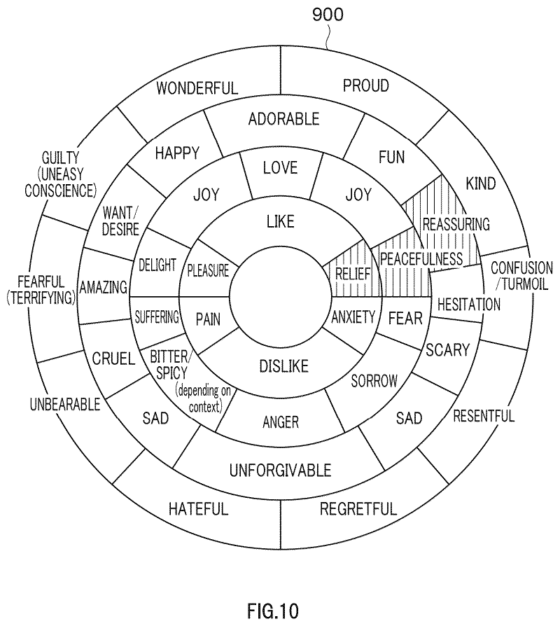

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to:
acquire image information of a physical object using an image acquisition device of an externally wearable information processing terminal,
acquire audio information using an audio acquisition device,
transmit the acquired image information and audio information to an information processing device via a communication network,
restore the image information on the information processing device and extract character information through character recognition processing,
extract important vocabulary and generate summarized string information from the character information by applying language processing algorithms,
convert the acquired or received audio information into string information via speech recognition processing,
apply translation processing to the string information converted from audio or extracted from the image,
transmit the analyzed summary information or translation information to the information processing terminal and display the information as an overlay within a visually recognizable region, and
generate a control input sentence for information extraction or summary generation using a generative information generation model and use it in related information processing.

### Supplementary 2

The system according to supplementary 1, wherein the processor is configured to automatically identify a processing target region from the acquired image information and preferentially execute processing with respect to string information within that region.

### Supplementary 3

The system according to supplementary 1,
wherein the processor is configured to sequentially and immediately perform speech recognition processing and translation processing in accordance with sequentially acquired audio information and overlay-display the result within a visually recognizable region of the information processing terminal.

### Application Example 1

### Supplementary 1

A system comprising a processor,
wherein the processor is configured to:
acquire environmental information using an optical information acquisition
component of a body-mounted information terminal,
acquire audio information using an audio information acquisition component,
encrypt and transmit the acquired environmental information and audio information to an external information processing apparatus,
perform character recognition processing on the received environmental information at the external information processing apparatus to extract information,
apply natural language processing technology to the extracted information to identify important information and perform compression processing,
apply audio signal recognition technology to the received audio information to convert it into symbol information,
convert the symbol information into another information representation,
attach information estimated by emotion estimation technology to the analyzed and converted information and transmit it to a demand terminal, and perform display control based on the transmitted information.

### Supplementary 2

The system according to supplementary 1, wherein the processor is configured to extract multiple regions of interest from the acquired environmental information and perform character recognition processing and information extraction for each region.

### Supplementary 3

The system according to supplementary 1, wherein the processor is configured to estimate a user's emotional state by analyzing facial information or the like simultaneously with the acquisition of audio information, and reflect the estimated emotional state in the analysis result or content to be presented.

### Example 2

### Supplementary 1

A system comprising a processor,
wherein the processor is configured to:
acquire external information using an imaging unit of an information processing device,
acquire audio information using an acoustic sensor unit of the information processing device,
transmit the acquired external information and audio information from the information processing device to an information analysis device,
analyze the transmitted external information to extract symbolic information,
apply natural language related technology to the extracted symbolic information to perform summarization and key point extraction,
analyze the transmitted audio information and convert it into symbolic information,
perform language conversion processing on the symbolic information,
extract attribute states by applying emotion determination technology to both the external information and the audio information,
integrate and transmit the analysis result, the language conversion result, and the attribute states to the information processing device for display, and
visually display the integrated information within a perceptible region of a user using the information processing device.

### Supplementary 2

The system according to supplementary 1, wherein the processor is configured to extract a predetermined feature area from the acquired external information and analyze specific symbolic information within the feature area.

### Supplementary 3

The system according to supplementary 1, wherein the processor is configured to apply audio analysis technology and emotion determination technology based on the acquired audio information, and display the analysis result and determination result in real time.

### Application Example 2

### Supplementary 1

A system comprising a processor,
wherein the processor is configured to:
acquire information through an image acquisition unit,
collect audio data through an acoustic sensor,
transmit the acquired information and collected audio data to an information processing device,
perform information extraction processing to obtain character data from the transmitted information,
analyze the extracted character data to extract key components and generate summary information,
perform audio analysis processing on the transmitted audio data to convert the audio data into character data,
perform translation processing on the character data converted from the audio data, generate display information based on the analysis or translation results and transmit the display information to an information display device,
estimate an emotional state based on the analysis target data and user state recognition data,
generate output information based on the summary information, translation result, and emotional state and
provide the output information to an information presentation device, and
generate the output information by using a generative processing engine,
wherein the generative processing engine receives instruction information as an input sentence.

### Supplementary 2

The system according to supplementary 1, wherein the processor is configured to specify a target region within the acquired information and perform analysis processing on predetermined data within the specified region.

### Supplementary 3

The system according to supplementary 1, wherein the processor is configured to conduct speech recognition processing based on the collected audio data, and display the recognition result and analysis result in real-time on the information presentation device.

What is claimed is:

1. A system comprising a processor,
wherein the processor is configured to:
captures visual information using a camera of a wearable device,
collects audio information using a microphone,
transmits the captured visual information and the collected audio information,
analyzes the transmitted visual information and extracts text,
extracts important keywords from the extracted text and generates a summary using natural language processing techniques,
analyzes the transmitted audio information and converts audio to text,
translates the text converted from audio, and
transmits and displays the analyzed and translated results to the wearable device.

2. The system according to claim 1, wherein the processor further identifies a region from the captured visual information and analyzes specific text within the identified region.

3. The system according to claim 1, wherein the processor further applies speech recognition technology based on the collection of audio information and displays the analysis result in real time.
